(19) United States
(12) Patent Application Publication
(10) Pub. No.: US 2018/0307427 A1
(43) Pub. Date: Oct. 25, 2018

(54) STORAGE CONTROL APPARATUS AND STORAGE CONTROL METHOD

(71) Applicant: FUJITSU LIMITED, Kawasaki-shi (JP)

(72) Inventors: Takeshi WATANABE, Kawasaki (JP); YOSHINARI SHINOZAKI, Kawasaki (JP); Marino Kajiyama, Yokohama (JP); Toshio Kikuchi, Sagamihara (JP); YOSHIHITO KONTA, Kawasaki (JP); Norihide KUBOTA, Kawasaki (JP); Yusuke Kurasawa, Nagano (JP); Yusuke Suzuki, Kawasaki (JP); Yuji TANAKA, Inagi (JP); Naohiro Takeda, Zushi (JP)

(73) Assignee: FUJITSU LIMITED, Kawasaki-shi (JP)

(21) Appl. No.: 15/955,866

(22) Filed: Apr. 18, 2018

(30) Foreign Application Priority Data
Apr. 20, 2017 (JP) 2017-083353

(51) Int. Cl. G06F 3/06

(52) U.S. Cl. CPC G06F 3/0631; G06F 3/0644; G06F 3/0647; G06F 3/0689; G06F 3/0665; G06F 3/0604; G06F 3/0656

(57) ABSTRACT

A storage control apparatus includes a memory, and a processor coupled to the memory and configured to execute a capacity expansion on a storage group including a plurality of storage devices, generate a plurality of first data storage regions in accordance with the number of storage devices within the storage group after the capacity expansion, and execute data rearrangement within the storage group after the capacity expansion for each of the plurality of first data storage regions.

### CROSS-REFERENCE TO RELATED APPLICATION

This application is based upon and claims the benefit of priority of the prior Japanese Patent Application No. 2017-83353, filed on Apr. 20, 2017, the entire contents of which are incorporated herein by reference.

### FIELD

The embodiment discussed herein is related to a storage control apparatus and a storage control method.

### BACKGROUND

Storage systems include multiple storage devices and record and manage large amounts of data to be handled for information processing. In addition, in recent years, storage systems, each of which includes, as storage devices, solid state drives (SSDs) that store data at a higher speed than hard disk drives (HDDs), are widely used.

Since amounts of data to be stored in storage systems have been increasing year by year, attention has been paid to a technique for efficiently using storage regions within the storage systems and reducing the capacities of physical storage regions to be actually used.

As the technique for reducing the capacities of physical storage regions, there is thin provisioning. Thin provisioning manages, as a pool (storage pool), a Redundant Array of Inexpensive Disks (RAID) group formed by making storage devices redundant and assigns the capacities of the storage devices based on amounts of data written to virtualized logical volumes.

Examples of related art are Japanese Laid-open Patent Publication No. 2010-79886 and Japanese National Publication of International Patent Application No. 2014-506367.

### SUMMARY

According to an aspect of the invention, a storage control apparatus includes a memory, and a processor coupled to the memory and configured to execute a capacity expansion on a storage group including a plurality of storage devices, generate a plurality of first data storage regions in accordance with the number of storage devices within the storage group after the capacity expansion, and execute data rearrangement within the storage group after the capacity expansion for each of the plurality of first data storage regions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a storage control apparatus;

FIG. 2 is a diagram illustrating an example of a configuration of a storage control system;

FIG. 3 is a diagram illustrating an example of a pool;

FIG. 4 is a diagram illustrating an example of a RAID unit;

FIG. 5 is a diagram illustrating an example of relationships between the number of devices of a disk pool and the size of a RAID unit;

FIG. 6 is a diagram illustrating an example of the acquisition of a RAID unit;

FIG. 7 is a diagram illustrating an example of the release of a RAID unit;

FIG. 8 is a diagram describing a method of managing user data and logical physical meta to be written to a disk pool;

FIG. 9 is a diagram illustrating an example of the format of a meta address;

FIG. 10 is a diagram illustrating an example of the format of logical physical meta;

FIG. 11 is a diagram illustrating an example of the additional installation of a disk in a disk pool;

FIG. 12 is a diagram illustrating an example of a hardware configuration of the storage control apparatus;

FIG. 13 is a diagram describing an example of a DPE process;

FIG. 14 is a flowchart of entire operations to be executed in the DPE process;

FIG. 15 is a diagram describing an example of the DPE process to be executed on a meta address;

FIG. 16 is a diagram describing an example of the DPE process to be executed on logical physical meta;

FIG. 17 is a flowchart of the DPE process to be executed on logical physical meta;

FIG. 18 is a diagram describing an example of the DPE process to be executed on user data;

FIG. 19 is a flowchart of the DPE process to be executed on user data;

FIG. 20 is a diagram describing an example of IO control during the DPE process; and

FIG. 21 is a flowchart of the IO control during the DPE process.

### DESCRIPTION OF EMBODIMENT

In thin provisioning, the capacity of a storage device is logically increased, but a physical storage capacity is not increased. Thus, a storage device is additionally installed when a margin of the physical storage capacity is reduced. Units (units in which data is striped) of physical assignment in thin provisioning are storage region units that are referred to as chunks.

Upon the additional installation of a storage device, capacity expansion is executed regardless of the sizes (chunk sizes) of the chunks. In this case, for example, if the capacity expansion is executed on a storage system handling management data to be used to manage physical addresses of user data, physical position information of the management data may be changed.

Thus, if the number of storage devices is increased depending on the chunk sizes before the additional installation, the storage device may be additionally installed without a change in the physical position information. However, when the storage device is additionally installed, the number of storage devices included in each RAID group increases, and the degree of freedom of the expansion of a storage capacity is reduced.

According to an aspect, an object of the present disclosure is to provide a storage control apparatus and a storage control method that may improve the degree of freedom of the expansion of a storage capacity.

Hereinafter, an embodiment is described with reference to the accompanying drawings.

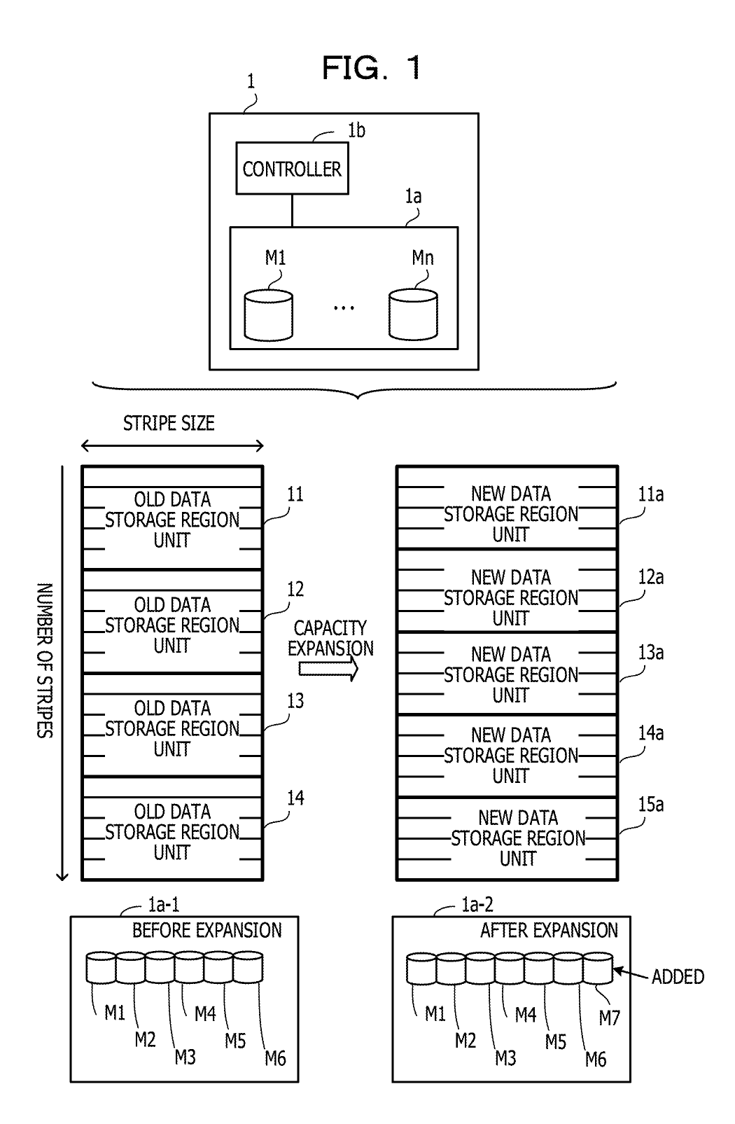

FIG. 1 is a diagram illustrating an example of a configuration of a storage control apparatus. A storage control apparatus 1 includes a storage group 1a and a controller 1b. The storage group 1a includes multiple storage devices M1, . . . , and Mn.

Upon the execution of capacity expansion on the storage group 1a, the controller 1b generates new data storage region units based on the number of storage devices within the storage group after the capacity expansion. Then, the controller 1b executes data rearrangement within the storage group after the capacity expansion for each of the new data storage region units.

A storage group 1a-1 is the storage group 1a before the capacity expansion and includes storage devices M1, . . . , and M6. A storage region of the storage group 1a-1 includes old data storage region units 11, . . . , and 14, while each of the old data storage region units 11, . . . , and 14 is composed of 5 stripes.

It is assumed that the capacity of the storage group 1a-1 is expanded by adding a storage device M7 to the storage group 1a-1. A storage group 1a-2 is the storage group 1a after the capacity expansion and includes the storage devices M1, . . . , and M7. The controller 1b generates new data storage region units based on the number of the storage devices M1, . . . , and M7 within the storage group 1a-2 after the capacity expansion and executes the data rearrangement for the new data storage region units.

In the example illustrated in FIG. 1, a storage region of the storage group 1a-2 includes new data storage region units 11a, . . . , and 15a, while each of the new data storage region unit 11a, . . . , and 15a is composed of 4 stripes. The sizes of the stripes of the new data storage region unit 11a, . . . , and 15a after the capacity expansion are larger than the sizes of the stripes of the old data storage region units 11, . . . , and 14 before the capacity expansion.

In this manner, the storage control apparatus 1 generates new data storage region units based on the number of storage devices within the storage group after the capacity expansion and executes the data rearrangement in the new data storage region units. Thus, the degree of freedom of the expansion of the storage capacity may be improved, and small-scale expansion of the storage capacity may be executed, compared with the case where the storage capacity is executed by additionally installing a storage device, depending on old data storage region units.

System Configuration

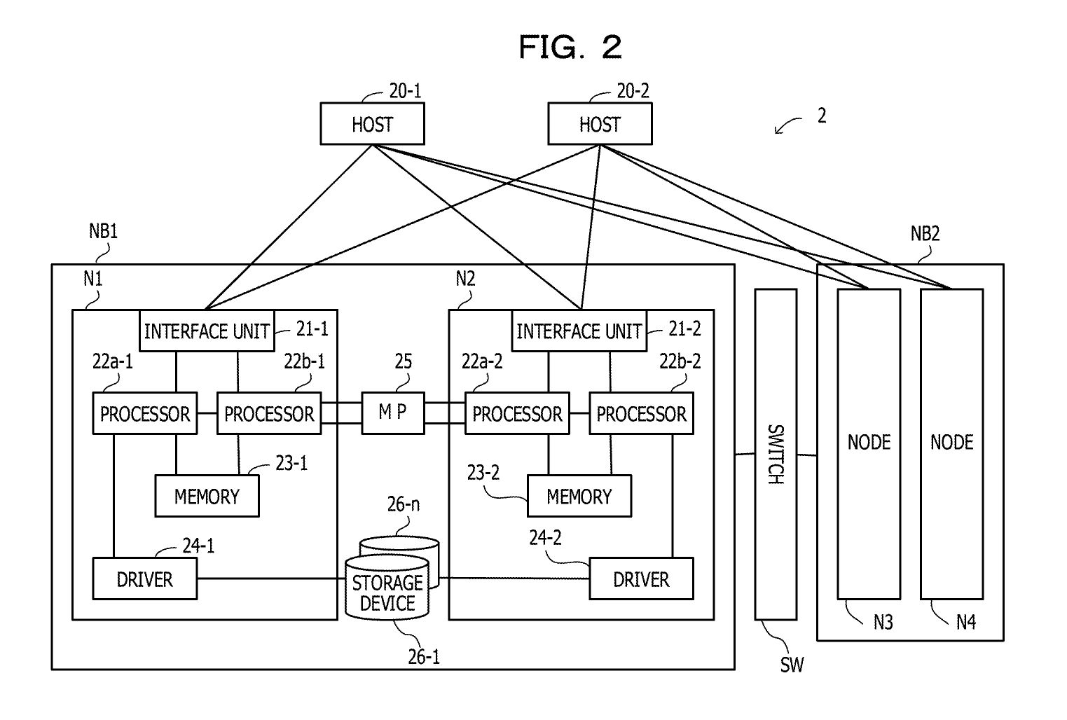

Next, a storage control system that includes functions of the storage control apparatus 1 is described. FIG. 2 is a diagram illustrating an example of a configuration of the storage control system. A storage control system 2 includes node blocks NB1 and NB2, hosts 20-1 and 20-2, and a switch SW.

The node block NB1 includes a pair of nodes N1 and N2, while the node block NB2 includes a pair of nodes N3 and N4. The node block NB1 duplicates data between the nodes N1 and N2 and distributes loads of IO (input and output) processes that are processes of writing and reading data to and from storage. The node block NB2 executes the same operations as those of the node block NB1 between the nodes N3 and N4.

The node blocks NB1 and NB2 are connected to each other via the switch SW and have a scalable connection configuration that enables storage regions of the node blocks NB1 and NB2 to be expanded.

The node block NB1 includes storage devices 26-1, . . . , and 26-n (but an illustration of storage devices included in the node block NB2 is omitted). The nodes N1 and N2 execute IO control on data to be input to and output from the storage devices 26-1, . . . , and 26-n.

Specifically, the nodes N1 and N2 execute the IO control on the storage devices 26-1, . . . , and 26-n based on data read requests (read IO requests) from the hosts 20-1 and 20-2 and data write requests (write IO requests) from the hosts 20-1 and 20-2.

The node N1 includes an interface section 21-1, processors 22a-1 and 22b-1, a memory 23-1, and a driver 24-1. The node N2 includes an interface section 21-2, processors 22a-2 and 22b-2, a memory 23-2, and a driver 24-2.

The nodes N1 and N2 have the functions of the storage control apparatus 1 illustrated in FIG. 1. The processors 22a-1, 22b-1, 22a-2, and 22b-2 of the nodes N1 and N2 achieve the functions of the controller 1b. In addition, the storage devices 26-1, . . . , and 26-n correspond to the storage devices M1, . . . , and Mn included in the storage group 1a.

The interface section 21-1 among the constituent elements of the node N1 connects the node N1 to the hosts 20-1 and 20-2 via multiple paths. As the interface section 21-1, an expansion card for host (EC-H) is used, for example.

The EC-H is connected to an interface adapter to be used to build a storage area network (SAN). For example, the EC-H is connected to a large-scale Fiber Channel (FC) SAN using an optical fiber, a small- or medium-scale Internet Small Computer System Interface (iSCSI) SAN using an Internet Protocol (IP) network, or the like.

The processors 22a-1 and 22b-1 are, for example, central processing units (CPUs), micro processing units (MPUs), or the like and have a multi-processor configuration and control entire functions included in the node N1.

The memory 23-1 is used as a main memory of the node N1 and temporarily stores a portion of a program to be executed by the processors 22a-1 and 22b-1 and various types of data to be used for processes by the program or temporarily stores the entire program and the various types of data.

The driver 24-1 transfers data between the processors 22a-1 and 22b-1 and the storage devices 26-1, . . . , and 26-n. As the driver 24-1, a Peripheral Component Interconnect Express switch (PCIe SW) that executes drive transfer on data in accordance with the Peripheral Component Interconnect Express (PCIe) protocol is used, for example. Constituent elements of the node N2 are the same as those of the node N1, and a description thereof is omitted.

A middle plane (MP) 25 is a transfer path that interconnects communication between the nodes N1 and N2 and is made redundant.

The storage devices 26-1, . . . , and 26-n are, for example, SSDs and form a redundant array. The storage devices 26-1, . . . , and 26-n are connected to the driver 24-1 of the node N1 and the driver 24-2 of the node N2 and shared by the nodes N1 and N2.

As the storage devices 26-1, . . . , and 26-n, SSDs (NVMe_SSDs) that conform to Non-Volatile Memory Express (NVMe) and are connected to the nodes N1 and N2 via PCIe are used, for example.

Pools

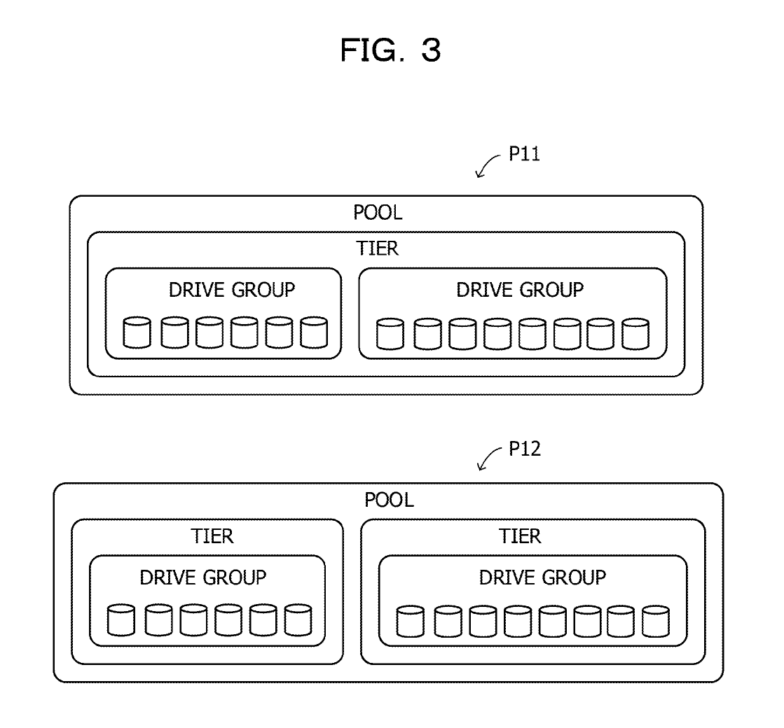

FIG. 3 is a diagram illustrating an example of a pool. The storage devices 26-1, . . . , and 26-n illustrated in FIG. 2 are managed by the pool. The pool is a virtual set of storage devices and is divided into a virtual pool P11 and a tiered pool P12.

When storage is tiered (tiering), a pool that includes one tier (or layer) in one pool is the virtual pool P11, and a pool that includes two or more tiers in one pool is the tiered pool P12.

Each of the tiers includes one or more disk pools. Each of the disk pools includes 6 to 24 storage devices (disks) and corresponds to a RAID.

Storage spaces of the storage devices are composed of multiple stripes. In data writing, divided data is written to a stripe (striping), parities are calculated, the results of the calculation are held, and the data is protected by the parities. Thus, for example, two of storage devices included in each of the disk pools are used as parity devices storing parity data (P parity and Q parity).

If one storage device is stopped being used due to a failure or the like, a rebuild process of rebuilding data stored in the stopped storage device and storing the data in another storage device is executed. In this case, a preliminary storage device that is referred to as hot spare is used. Thus, for example, one of storage devices included in each of the disk pools is used as a hot spare.

RAID Units

A unit to be physically assigned in thin provisioning is a fixed chunk in general. Each chunk corresponds to a respective RAID unit. In the following description, chunks are referred to as RAID units.

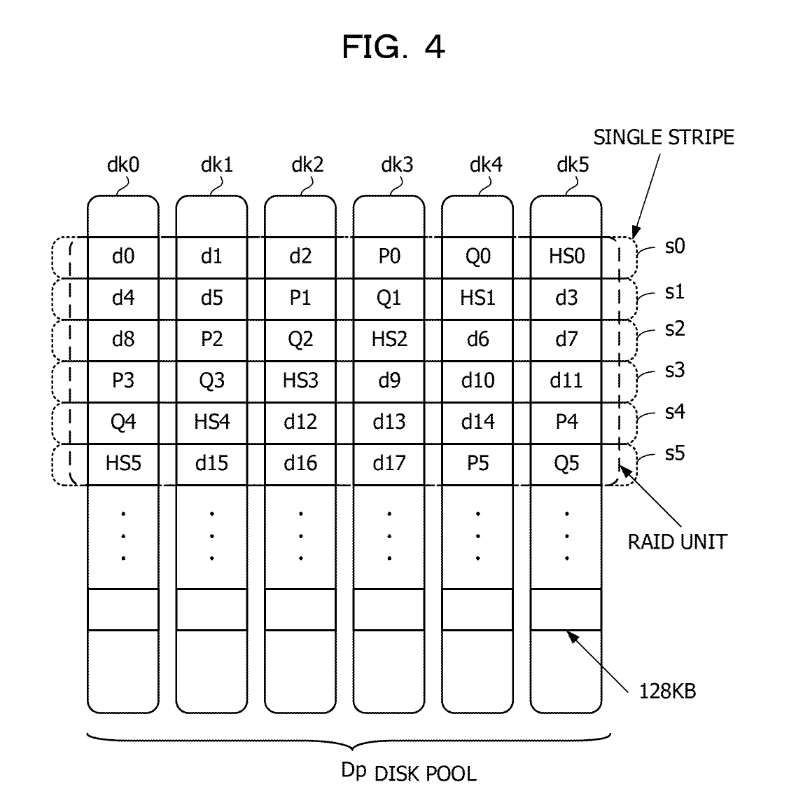

FIG. 4 is a diagram illustrating an example of a RAID unit. A disk pool Dp includes storage devices dk0, . . . , and dk5. A storage space of the disk pool Dp is composed of stripes. Each of the stripes extends across the storage devices dk0, . . . , and dk5 and has blocks of the storage devices dk0, . . . , and dk5 (each of the blocks has, for example, a capacity of 128 KB).

Storage states of stripes s0 to s5 are described below in the order of the blocks of the storage devices dk0, . . . , and dk5. In the stripe s0, data d0, data d1, data d2, a parity P0, a parity Q0, and a hot spare HS0 are stored. In the stripe s1, data d4, data d5, a parity P1, a parity Q1, a hot spare HS1, and data d3 are stored.

In the stripe s2, data d8, a parity P2, a parity Q2, a hot spare HS2, data d6, and data d7 are stored. In the stripe s3, a parity P3, a parity Q3, a hot spare HS3, data d9, data d10, and data d11 are stored.

In the stripe s4, a parity Q4, a hot spare HS4, data d12, data d13, data d14, and a parity P4 are stored. In the stripe s5, a hot spare HSS, data d15, data d16, data d17, a parity P5, and a parity Q5 are stored.

In the aforementioned storage states, storage regions of the stripes s0, . . . , and s5 form a single RAID unit, for example. The size of each RAID unit is a multiple of the size of each stripe or equal to the stripe size×n (n is a positive integer). In this case, n is set in such a manner that each RAID unit has a capacity of a predetermined value (for example, approximately 24 MB).

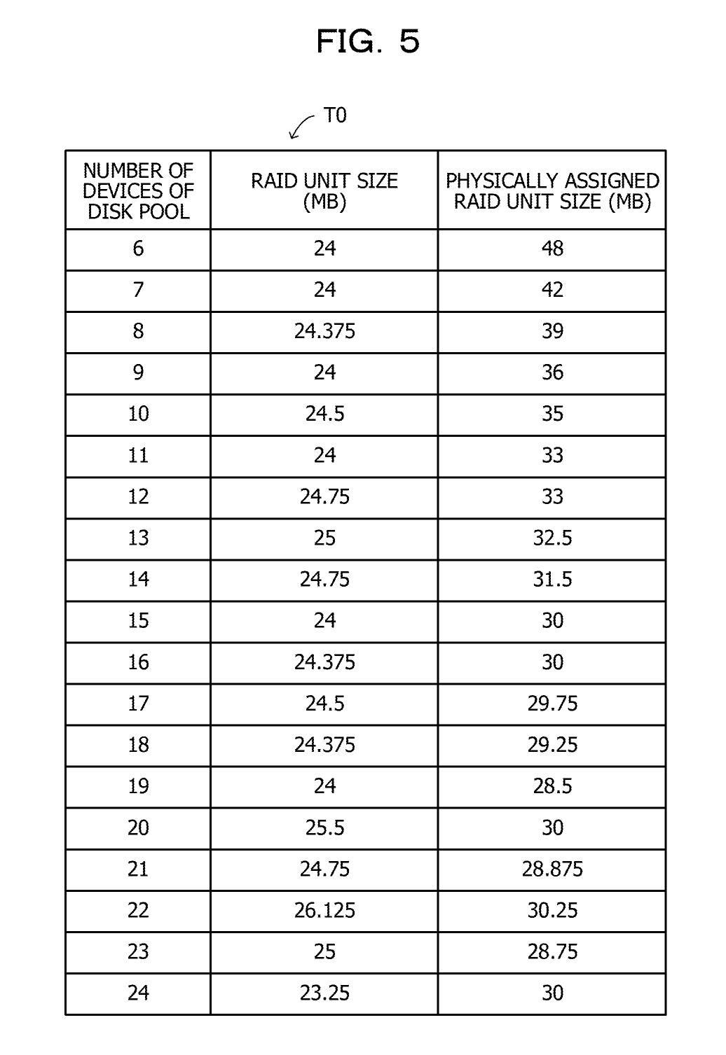

FIG. 5 is a diagram illustrating relationships between the number of devices of a disk pool and the size of a RAID unit. A table T0 includes, as items, “number of devices of disk pool”, “RAID unit size (MB)”, and “physically assigned RAID unit size (MB)”.

“Number of devices of disk pool” indicates the numbers of storage devices of the single disk pool. “RAID unit size” indicates RAID unit sizes of storage regions for storing only data excluding parities and hot spares. “Physically assigned RAID unit size” indicates RAID unit sizes of storage regions for storing data, parities, and hot spares.

A row in which 6 is indicated in “number of devices of disk pool” in the table T0 indicates that 6 storage devices are 3 storage devices for storing data, 2 storage devices for storing parities, and 1 storage device for storing a hot spare. As the number of devices of the disk pool is increased to 7, 8, . . . , the number of storage devices for storing data is increased (the number of storage devices for storing parities is 2 and not changed, and the number of storage devices for storing a hot spare is 1 and not changed).

A row in which 24 is indicated in “number of devices of disk pool” in the table T0 indicates that 24 storage devices are 21 storage devices for storing data, 2 storage devices for storing parities, and 1 storage device for storing a hot spare.

Acquisition and Release of RAID Units

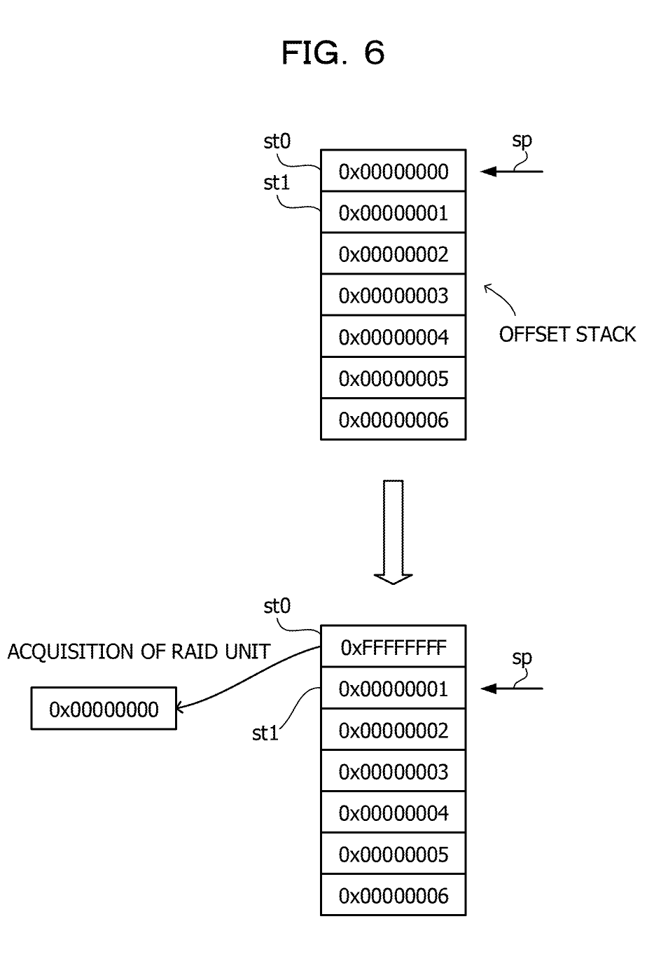

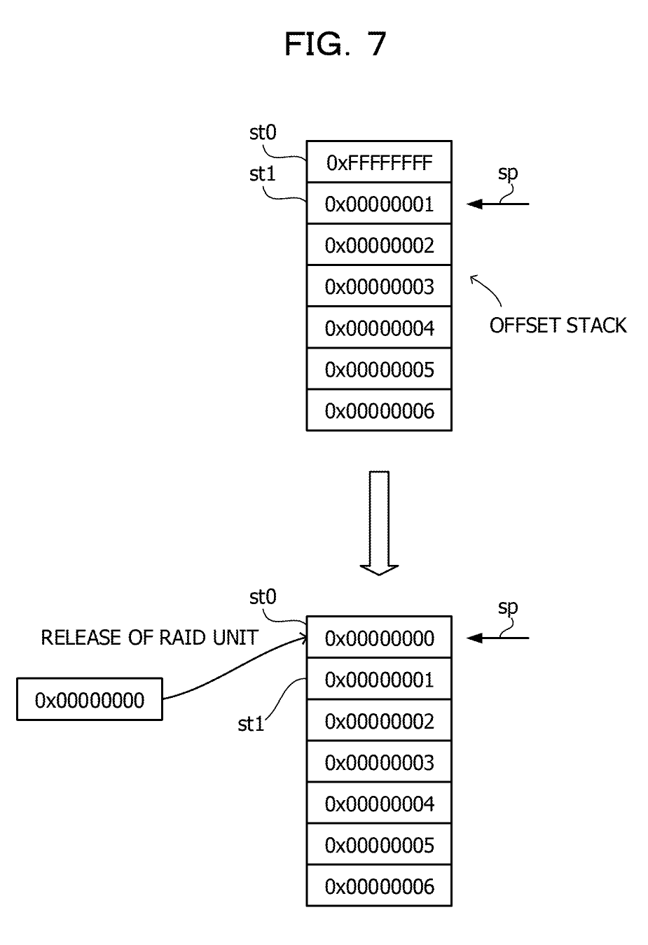

Next, the acquisition and release of a RAID unit are described with reference to FIGS. 6 and 7. FIG. 6 is a diagram illustrating an example of the acquisition of the RAID unit. In initial settings, RAID unit numbers are stored as strings in order from the top of an offset stack in the offset stack. Then, a RAID unit number stored at a position indicated by a stack pointer is acquired from the offset stack.

In a procedure for the acquisition, the RAID unit number stored at the position indicated by the stack pointer is acquired, an invalid value (0xFFFFFFFF) is inserted at the position from which the RAID unit number has been acquired, and the stack pointer is downwardly shifted by one stack.

In the example illustrated in FIG. 6, the stack pointer sp is positioned at a stack st0 within the offset stack. Thus, the RAID unit number (0x00000000) stored in the stack st0 is acquired.

After the acquisition of the RAID unit number (0x00000000), the invalid value (0xFFFFFFFF) is inserted in the stack st0, and the stack pointer sp is downwardly shifted by one stack to the stack st1.

FIG. 7 is a diagram illustrating an example of the release of the RAID unit. In a procedure for the release of the RAID unit, operations are executed in the order opposite to the order of the operations executed in the aforementioned acquisition procedure. Specifically, the stack pointer is upwardly returned, and the RAID unit number is inserted in the stack indicated by the returned stack pointer.

In the example illustrated in FIG. 7, the stack pointer sp is positioned at the stack st1 included in the offset stack. Thus, the stack pointer sp is upwardly shifted by one stack to the stack st0. The invalid value (0xFFFFFFFF) is already inserted in the stack st0 indicated by the shifted stack pointer sp, and the RAID unit number (0x00000000) to be released is inserted in the stack st0.

Management of Life of SSDs

SSDs are used as the storage devices 26-1, . . . , and 26-n of the storage control system 2, for example. The SSDs may be accessed at a higher speed than HDDs, but random writing (random access) may not be suitable for the SSDs according to characteristics of devices of the SSDs, and storage elements of the SSDs may be easily degraded due to data writing such as the random writing and data deletion. Thus, the life of the SSDs is managed in order to secure the reliability of the SSDs.

As the management of the life of the SSDs, the performance of the random writing is improved. In this case, data is managed as a continuous long format and additionally written as continuous data to the SSDs.

In addition, data deduplication and data compression are executed. The deduplication is to divide a file into blocks having arbitrary lengths and remove duplicated data for each of the divided blocks.

The amount of data to be written to the SSDs may be reduced by a combination of the deduplication and the data compression. In addition, the life of the SSDs may be maximized by executing additional writing to write data to boundaries between stripes and boundaries between pages of the SSDs.

As management data to be used for the aforementioned deduplication and the additional writing, logical physical meta information and meta addresses are used.

The logical physical meta information (hereinafter abbreviated to logical physical meta) is data to be used to manage physical addresses at which user data is stored in the storage devices. The meta addresses are data to be used to manage physical addresses at which the logical physical meta is stored in the storage devices (or on memories).

User data units (also referred to as data logs) indicate storage regions storing compressed user data. For example, each of the user data units includes a data portion for storing data compressed in units of 8 KB and a header portion (also referred to as reference meta). In the header portions, hash values of compressed data, information that indicates logical physical meta and is used to point the compressed data, and the like are stored. Hereinafter, the user data units are abbreviated to and expressed by user data. The hash values are used as keywords to be used to search duplication.

Since the meta addresses, the logical physical meta, and the user data are stored in RAID units, information that points physical positions of the logical physical meta from the meta addresses, and information that points physical positions of the user data from the logical physical meta, are specified by RAID unit numbers and offset logical block addresses (LBAs).

Management of Meta Structure

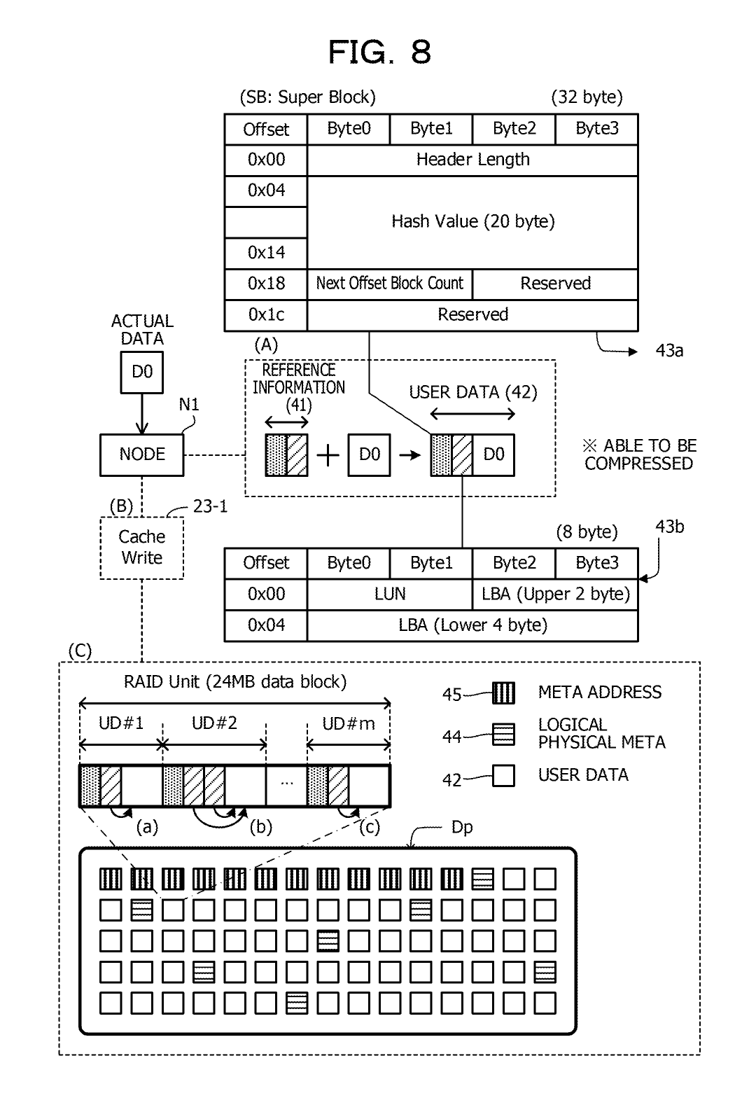

Next, the management of a meta structure (user data, logical physical meta, and a meta address) is described. FIG. 8 is a diagram describing a method of managing user data and logical physical meta to be written to the disk pool. As indicated by (A), when actual data D0 is to be written to the disk pool Dp, user data 42 is generated by adding reference information 41 to the actual data D0.

The reference information 41 includes a super block (SB) 43a and reference logical unit number (LUN) and LBA information 43b.

The SB 43a is set to, for example, 32 bytes and includes a header length indicating the length of the reference information 41, a hash value of the actual data D0, and the like.

The reference LUN and LBA information 43b is set to, for example, 8 bytes and includes an LUN of a logical region in which the actual data D0 is stored and an LBA indicating a position at which the actual data D0 is stored. In other words, the reference LUN and LBA information 43b includes information on a logical storage destination of the actual data D0.

When actual data Dx of which details are the same as those of the actual data D0 is to be written, reference LUN and LBA information 43b, which includes an LUN of a logical region serving as a storage destination of the actual data Dx and an LBA indicating a position at which the actual data Dx is to be stored, is generated. In addition, the reference LUN and LBA information 43b of the actual data Dx is added to the user data 42 of the actual data D0.

As indicated by (B), the user data 42 is temporarily stored in the memory 23-1. Then, control is executed to additionally write multiple user data items corresponding to multiple actual data items to the memory 23-1 and write the user data to a disk pool Dk in units of predetermined data amount (of, for example, 24 MB).

In an example indicated by (C), data obtained by synthesizing user data UD#1, UD#2, . . . , and UD#m with each other is written to the disk pool Dp. Arrows (a), (b), and (c) illustrated in the example indicated by (C) indicate correspondence relationships between reference LUN and LBA information 43b and actual data. In the disk pool Dp, the user data 42, a meta address 45, and logical physical meta 44 are written.

The logical physical meta 44 is information in which logical addresses are associated with physical addresses. The meta address 45 is positional information of the logical physical meta 44 in the disk pool Dp. A meta address 45 and logical physical meta 44 are written to the disk pool Dp for each RAID unit.

User data 42 and logical physical meta 44 are sequentially additionally written to the disk pool Dp every time data for a RAID unit is collected. Thus, as indicated by (C), the meta address 45 is written in a predetermined range (from the top to a predetermined position) of the disk pool Dp, and the user data 42 and the logical physical data 44 are stored in the disk pool Dp in a mixed manner.

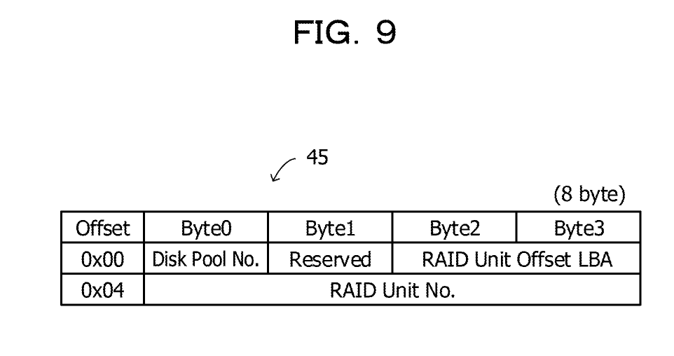

FIG. 9 is a diagram illustrating an example of the format of the meta address. The meta address 45 includes identification information (disk pool No.) of the disk pool Dp. The meta address 45 includes identification information (RAID unit No.) identifying the RAID unit of the logical physical meta 44 corresponding to the meta address 45.

Furthermore, the meta address 45 includes information (RAID unit offset LBA) of positions that are within the RAID unit and at which the corresponding logical physical meta 44 exists. The logical physical meta 44 stored in the disk pool Dp may be searched by referencing the meta address 45.

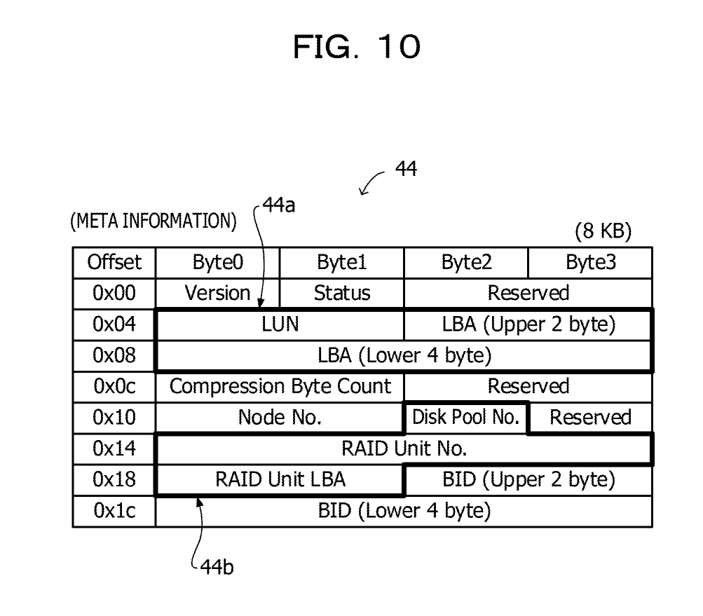

FIG. 10 is a diagram illustrating an example of the format of the logical physical meta. The logical physical meta 44 includes logical address information 44a, physical address information 44b, and the like. The logical address information 44a includes an LUN of a logical region in which the user data 42 is stored and an LBA indicating a position at which the user data 42 is stored.

In addition, the physical address information 44b includes the identification information (disk pool No.) of the disk pool Dp in which the user data 42 is stored, the identification information (RAID unit No.) of the RAID unit within the disk pool Dp, and positional information (RAID unit LBA) within the RAID unit.

Active Capacity Expansion Process by Additional Installation of Disk

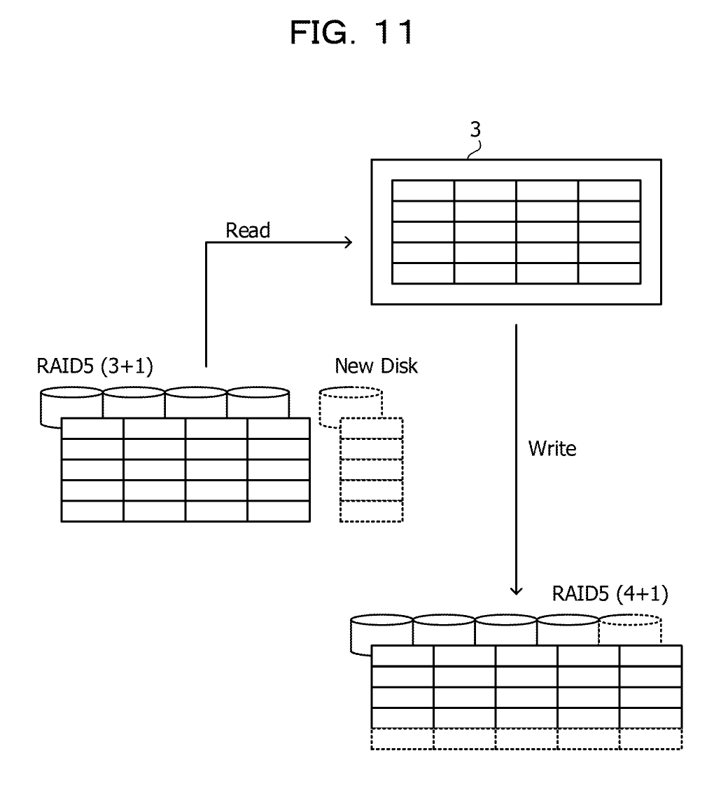

FIG. 11 is a diagram illustrating an example of the additional installation of a disk in a disk pool. When the number of storage devices of a disk pool is increased by active installation, an active capacity expansion process is executed.

In FIG. 11, as an example of additional installation in RAID5 (type of a RAID to which divided data blocks and parities are distributed and written to multiple disks), a storage device is additionally installed in RAIDS in such a manner that 3 data items and 1 parity are stored in each stripe before the additional installation and that 4 data items and 1 parity are stored in each stripe after the additional installation.

First, a staging process (process of reading data from storage devices of a disk pool and storing the read data in a temporary buffer) is executed to write the data to a region of the temporary buffer 3 for the disk pool before the additional installation. Then, the data stored in the temporary buffer 3 is written back to the storage devices of the disk pool after the additional installation.

The aforementioned operation is started in order from the top stripe of the storage devices included in the disk pool. In the aforementioned case, the data is read from the disk pool before the additional installation in units of the least common multiple of the size of each stripe of the disk pool (hereinafter referred to as old configuration) before the additional information and the size of each stripe of the disk pool (hereinafter referred to as new configuration) after the additional information. Then, the read data is temporarily stored in the temporary buffer 3. Then, parities are regenerated, and the data and the parities are written to the new configuration.

In the aforementioned active capacity expansion process, since the capacity expansion is executed regardless of RAID units before the additional installation, physical position information of logical physical meta and physical position information of user data may be shifted. If the number of storage devices is increased depending on RAID units before additional installation, a storage device may be additionally installed in such a manner that the physical position information does not change, but the degree of freedom of the storage capacity may be reduced and the scale of the expansion of the storage capacity may be increased.

Under such circumstances, techniques disclosed herein may improve the degree of freedom of the expansion of a storage capacity and achieve small-scale expansion of the storage capacity, compared with the case where the storage capacity is expanded by additionally installing a storage device, depending on RAID units.

Hardware Configuration

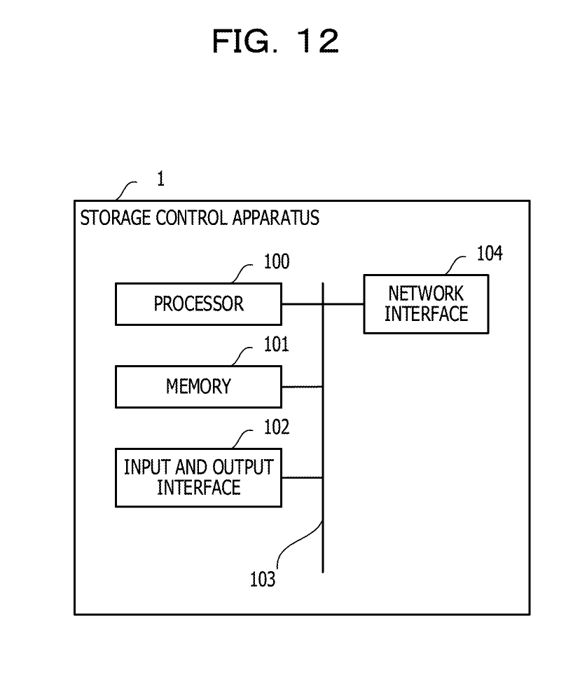

Next, a hardware configuration of the storage control apparatus 1 is described. FIG. 12 is a diagram illustrating an example of the hardware configuration of the storage control apparatus. The entire storage control apparatus 1 is controlled by a processor 100. The processor 100 functions as the controller 1b of the storage control apparatus 1.

The processor 100 is connected to a memory 101 and multiple peripheral devices via a bus 103. The processor 100 may be a multi-processor, as illustrated in FIG. 2. The processor 100 is, for example, a CPU, an MPU, a digital signal processor (DSP), an application specific integrated circuit (ASIC), or a programmable logic device (PLD). Alternatively, the processor 100 may be a combination of two or more of a CPU, an MPU, a DSP, an ASIC, and a PLD.

The memory 101 corresponds to the memories 23-1 and 23-2 illustrated in FIG. 2 and is used as a main storage device of the storage control apparatus 1. In the memory 101, a portion of a program of an operating system (OS) to be executed by the processor 100 and an application program is temporarily stored, or the program of the OS and the application program are stored. In the memory 101, various messages to be used for processes to be executed by the processor 100 are stored.

In addition, the memory 101 is used also as an auxiliary storage device of the storage control apparatus 1. In the memory 101, the program of the OS, the application program, and the various types of data are stored. In the case where the memory 101 is used as the auxiliary storage device, the memory 101 may include a magnetic recording medium that is a semiconductor storage device such as a flash memory or an SSD, an HDD, or the like.

The peripheral devices connected to the bus 103 are an input and output interface 102 and a network interface 104. The input and output interface 102 is connected to a monitor (for example, a light emitting diode (LED), a liquid crystal display (LCD), or the like) that functions as a display device that displays the state of the storage control apparatus 1 in accordance with a command from the processor 100.

In addition, the input and output interface 102 may be connected to an information input device such as a keyboard or a mouse and transmits a signal transmitted by the information input device to the processor 100.

Furthermore, the input and output interface 102 includes functions of the drivers 24-1 and 24-2 illustrated in FIG. 2 and is connected to storage devices. The input and output interface 102 functions as a communication interface that connects the storage control apparatus 1 to other peripheral devices.

For example, the input and output interface 102 may be connected to an optical driving device that uses laser light or the like to read a message recorded in an optical disc. The optical disc is a portable recording medium in which the message that is read by light reflection is recorded. Examples of the optical disc are a digital versatile disc, (DVD), a DVD random access memory (DVD-RAM), a compact disc read only memory (CD-ROM), a CD-Recordable (CD-R), and a CD-Rewritable (CD-RW).

The input and output interface 102 may be connected to a memory device or a memory reader or writer. The memory device is a recording medium that has a communication function of executing communication with the input and output interface 102. The memory reader or writer is a device that writes a message to a memory card or reads a message from the memory card. The memory card is a card-type recording medium.

The network interface 104 includes functions of the interface sections 21-1 and 21-2 illustrated in FIG. 2 and is connected to the hosts 20-1 and 20-2. The network interface 104 may have a function of a network interface card (NIC), a function of a radio local area network (LAN), and the like, for example. A signal, a message, and the like that are received by the network interface 104 are output to the processor 100.

Processing functions of the storage control apparatus 1 may be achieved by the aforementioned hardware configuration. For example, the storage control apparatus 1 may control storage by causing the processor 100 to execute predetermined programs.

The storage control apparatus 1 executes a program recorded in a computer-readable recording medium, thereby achieving the processing functions according to the embodiment, for example. The program in which details of processing to be executed by the storage control apparatus 1 are described may be recorded in various recording media.

For example, the program to be executed by the storage control apparatus 1 may be stored in the auxiliary storage device. The processor 100 loads a portion of the program stored in the auxiliary storage device or the entire program into the main storage device and executes the loaded program. The program may be recorded in a portable recording medium such as an optical disc, a memory device, or a memory card. For example, the program stored in the portable recording medium may be installed in the auxiliary storage device and executed under control by the processor 100. The processor 100 may read the program directly from the portable recording medium and execute the read program.

Disk Pool Expansion Process

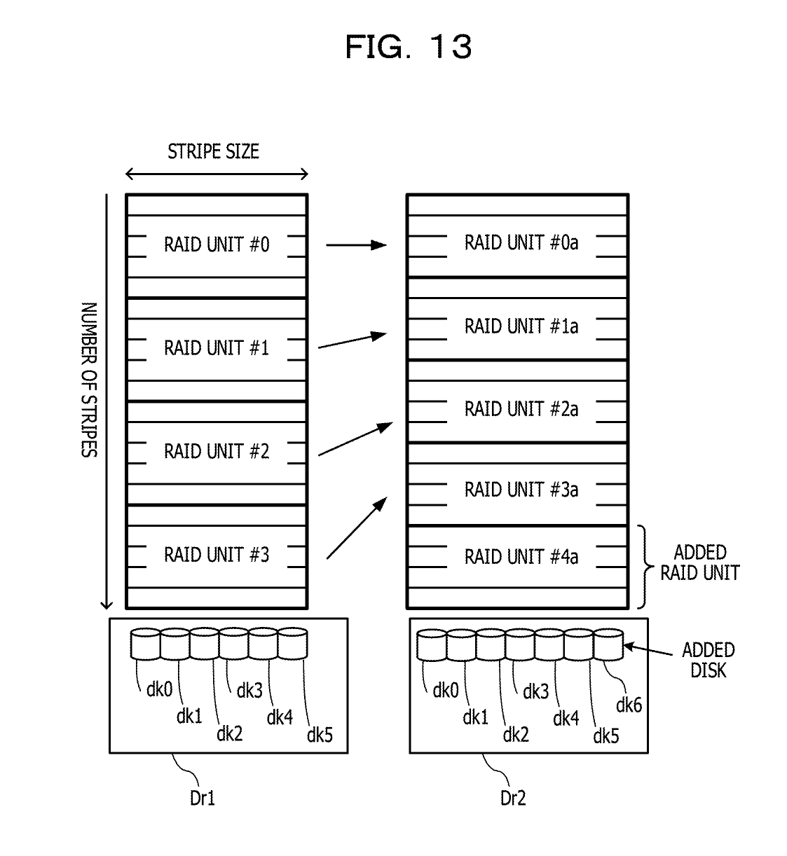

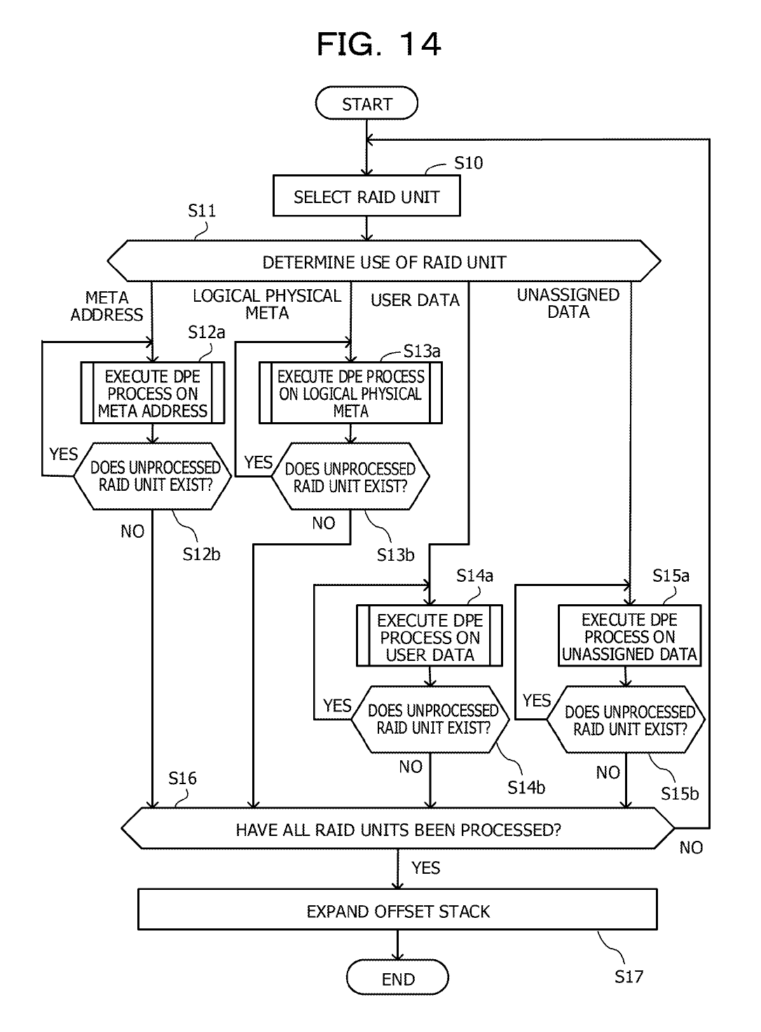

Next, entire operations to be executed in a disk pool expansion (DPE) process by the storage control apparatus 1 are described with reference to FIGS. 13 and 14. Hereinafter, the disk pool expansion process according to the embodiment is referred to as DPE process.

FIG. 13 is a diagram describing an example of the DPE process. Before the execution of the DPE process, a disk pool Dr1 includes storage devices dk0, . . . , and dk5. In a storage region of the disk pool Dr1, RAID units #0, . . . , and #3 (corresponding to old data storage region units) are stored. Each of the RAID units #0, . . . , and #3 has 5 stripes.

After the execution of the DPE process, a disk pool Dr2 includes disks dk0, . . . , and dk6, or the storage device dk6 is additionally installed. RAID units #0a, . . . , and #4a (corresponding to new data storage region units) are stored in a storage region of the disk pool Dr2, or the RAID unit #4a is newly added to the storage region of the disk pool Dr2.

In this case, the RAID units #0a, . . . , and #3a correspond to the RAID units #0, . . . , and #3 before the expansion. The number of stripes of each of the RAID units #0a, . . . , and #4a is 4 and reduced, compared with the number of stripes of each of the RAID units #0, . . . , and #3 before the expansion, but the sizes of the stripes of the RAID units #0a, . . . , and #4a are increased, compared with the sizes of the stripes of the RAID units #0, . . . , and #3 before the expansion.

In the disk pool Dr2 after the DPE process, the number of stripes of each of the RAID units is reduced, but the sizes of the stripes of the RAID units are increased. Since RAID units are stored in order from the top in the storage region expanded by the DPE process and an available region exists in the end of the storage region, a storage capacity is newly added by assigning a new RAID unit to the available region.

FIG. 14 is a flowchart of entire operations to be executed in the DPE process. The DPE process is executed in order from the top RAID unit in the storage region of the disk pool.

In step S10, the controller 1b selects a RAID unit to be processed.

In step S11, the controller 1b determines the use of the selected RAID unit or determines whether the DPE process is to be executed on a meta address, logical physical meta, user data, or unassigned data of the selected RAID unit. If the DPE process is to be executed on the meta address, a process proceeds to step S12a. If the DPE process is to be executed on the logical physical meta, the process proceeds to step S13a. If the DPE process is to be executed on the user data, the process proceeds to step S14a. If the DPE process is to be executed on the unassigned data, the process proceeds to step S15a.

In step S12a, the controller 1b executes the DPE process on the meta address.

In step S12b, the controller 1b determines whether or not an unprocessed RAID unit exists. If the unprocessed RAID unit exists, the process returns to step S12a in order to execute the DPE process on a meta address within the unprocessed RAID unit. If the unprocessed RAID unit does not exist, the process proceeds to step S16.

In step S13a, the controller 1b executes the DPE process on the logical physical meta.

In step S13b, the controller 1b determines whether or not an unprocessed RAID unit exists. If the unprocessed RAID unit exists, the process returns to step S13a in order to execute the DPE process on logical physical meta until the end of the storage region. If the unprocessed RAID unit does not exist, the process proceeds to step S16.

In step S14a, the controller 1b executes the DPE process on the user data.

In step S14b, the controller 1b determines whether or not an unprocessed RAID unit exists. If the unprocessed RAID unit exists, the process returns to step S14a in order to execute the DPE process on user data until the end of the storage region. If the unprocessed RAID unit does not exist, the process proceeds to step S16.

In step S15a, the controller 1b executes the DPE process on the unassigned data.

In step S15b, the controller 1b determines whether or not an unprocessed RAID unit exists. If the unprocessed RAID unit exists, the process returns to step S15a in order to execute the DPE process on unassigned data until the end of the storage region. If the unprocessed RAID unit does not exist, the process proceeds to step S16.

In step S16, the controller 1b determines whether or not the process has been completed on all RAID units. If the process has been completed, the process proceeds to step S17. If the process has not been completed, the process returns to step S10.

In step S17, the controller 1b expands the offset stack by adding an RAID unit number of an added RAID unit to the offset stack and expands the storage capacity of the disk pool.

DPE Process to be Executed on Meta Address

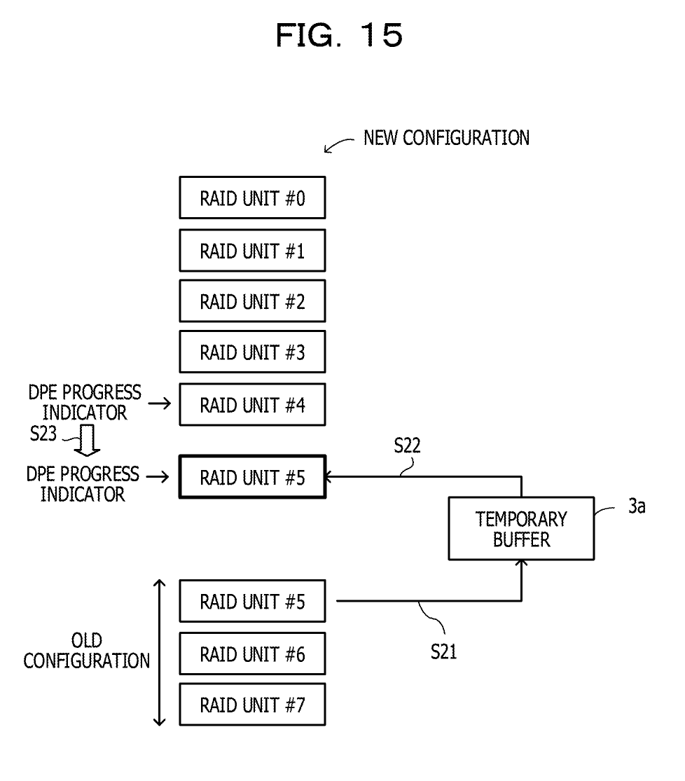

FIG. 15 is a diagram describing an example of the DPE process to be executed on the meta address. It is assumed that the DPE process has been executed on meta addresses of the RAID units #0, . . . , and #4 and is executed on a meta address of the RAID unit #5.

In step S21, the controller 1b executes the staging process to store the meta address of the RAID unit #5 of the old configuration in the temporary buffer 3a.

In step S22, the controller 1b executes a process of writing the meta address stored in the temporary buffer 3a back to the RAID unit #5 of the new configuration.

In step S23, the controller 1b advances a DPE progress indicator for RAID units to the RAID unit #5. A RAID unit already indicated by the DPE progress indicator is treated as a RAID unit of the new configuration, while a RAID unit that has yet to be indicated by the DPE progress indicator is treated as a RAID unit of the old configuration. The order in which the DPE process is executed on RAID units may be secured since the progress of the DPE process is managed for each RAID unit.

In the DPE process executed on a meta address, a RAID unit may not be stored in the end of the storage region, and an available storage capacity may exist (and the meta address is stored in a region with a fixed capacity (of, for example, 24 MB). Thus, in the DPE process executed on the meta address, even when the storage region is expanded by the DPE process, a correspondence relationship between the meta address and an LBA does not change, compared with that before the expansion.

DPE process to be Executed on Logical Physical Meta

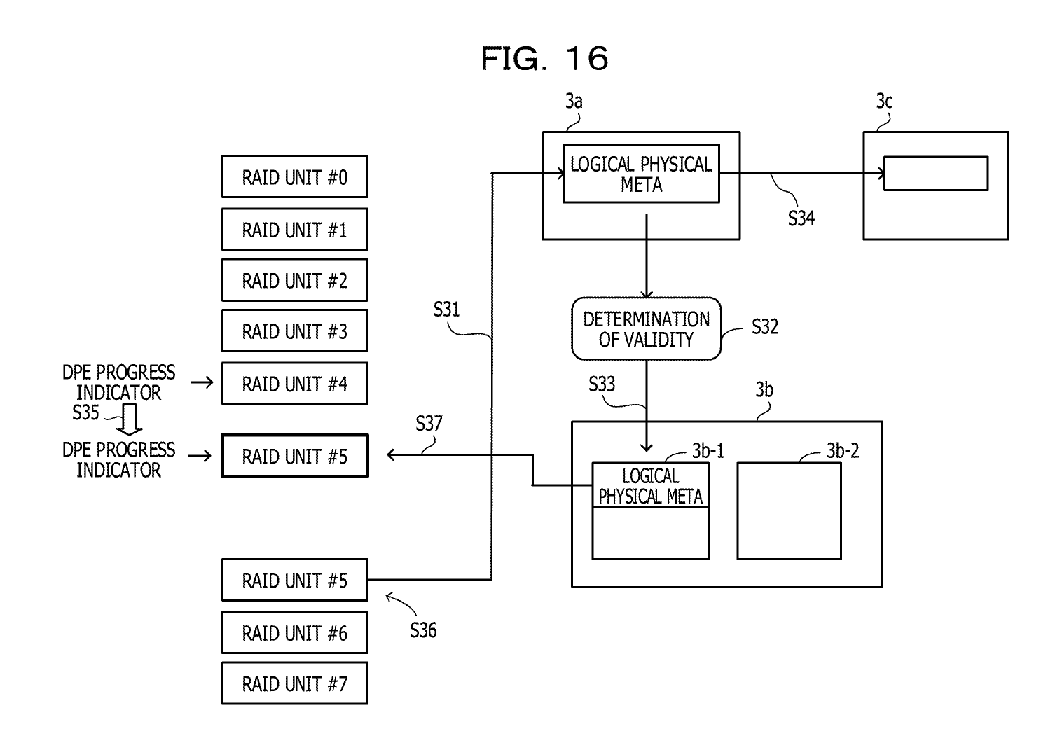

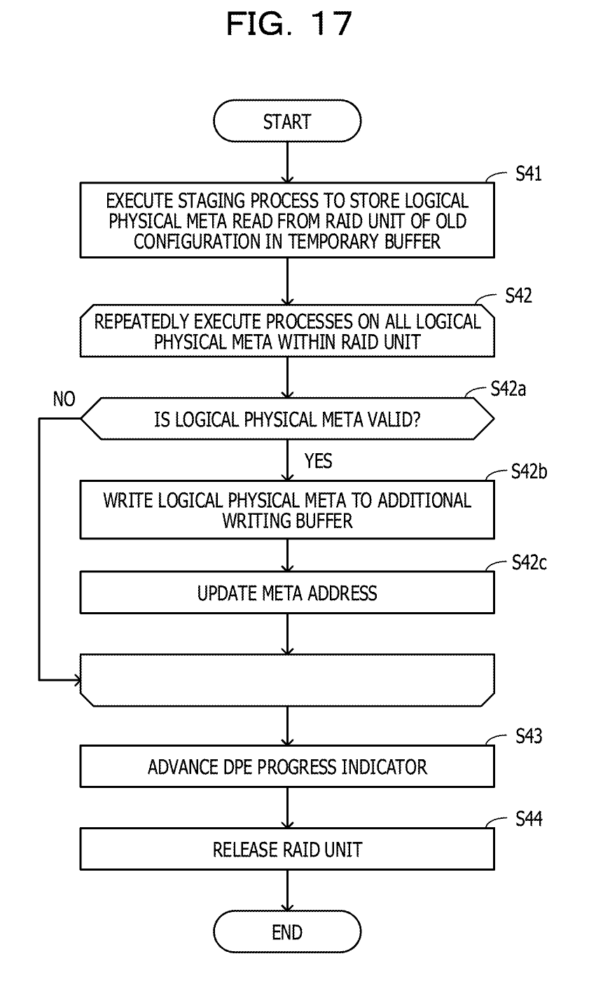

Next, the DPE process to be executed on the logical physical meta is described with reference to FIGS. 16 and 17. FIG. 16 is a diagram describing an example of the DPE process to be executed on the logical physical meta.

In step S31, the controller 1b executes the staging process to store logical physical meta of the RAID unit #5 of the old configuration in the temporary buffer 3a.

In step S32, the controller 1b determines whether the logical physical meta stored in the temporary buffer 3a is valid or invalid.

If the logical physical meta is valid, the controller 1b additionally writes the logical physical meta to a logical physical meta buffer region 3b-1 of an additional writing buffer 3b in step S33.

In step S34, the controller 1b updates the meta address, stored in a meta address cache memory 3c, of the logical physical meta since a physical address of the logical physical meta is changed. Processes of steps S31 to S34 are repeatedly executed on all logical physical meta stored in the temporary buffer 3a.

In step S35, the controller 1b advances the DPE progress indicator for RAID units.

In step S36, the controller 1b releases the RAID unit #5. In the case where the logical physical meta able to be made invalid exists in the RAID unit of the old configuration, the RAID unit is released upon the rebuilding of RAID units of the new configuration, the data rearrangement is not executed, and the amount of a task of executing the data rearrangement is reduced.

In step S37, the controller 1b writes the logical physical meta back to the RAID unit asynchronously with the DPE process when the additional writing buffer 3b (logical physical meta buffer region 3b-1) becomes full of the logical physical meta due to IO extension.

FIG. 17 is a flowchart of the DPE process to be executed on the logical physical meta.

In step S41, the controller 1b executes the staging process to store the logical physical meta read from the RAID unit #5 of the old configuration in the temporary buffer 3a.

In step S42, the controller 1b repeatedly executes processes of steps S42a, S42b, and S42c on all the logical physical meta within the RAID unit. When the processes of steps S42a to S42c are completed on all the logical physical meta, the process proceeds to step S43.

In step S42a, the controller 1b determines whether logical physical meta is valid or invalid. If the logical physical meta is valid, the process proceeds to step S42b. If the logical physical meta is not valid, the controller 1b executes a process of determining whether the next logical physical meta is valid or invalid.

In step S42b, the controller 1b writes the logical physical meta to the additional writing buffer 3b.

In step S42c, the controller 1b updates a meta address.

In step S43, the controller 1b advances the DPE progress indicator to the RAID unit.

In step S44, the controller 1b releases the RAID unit.

DPE Process to be Executed on User Data

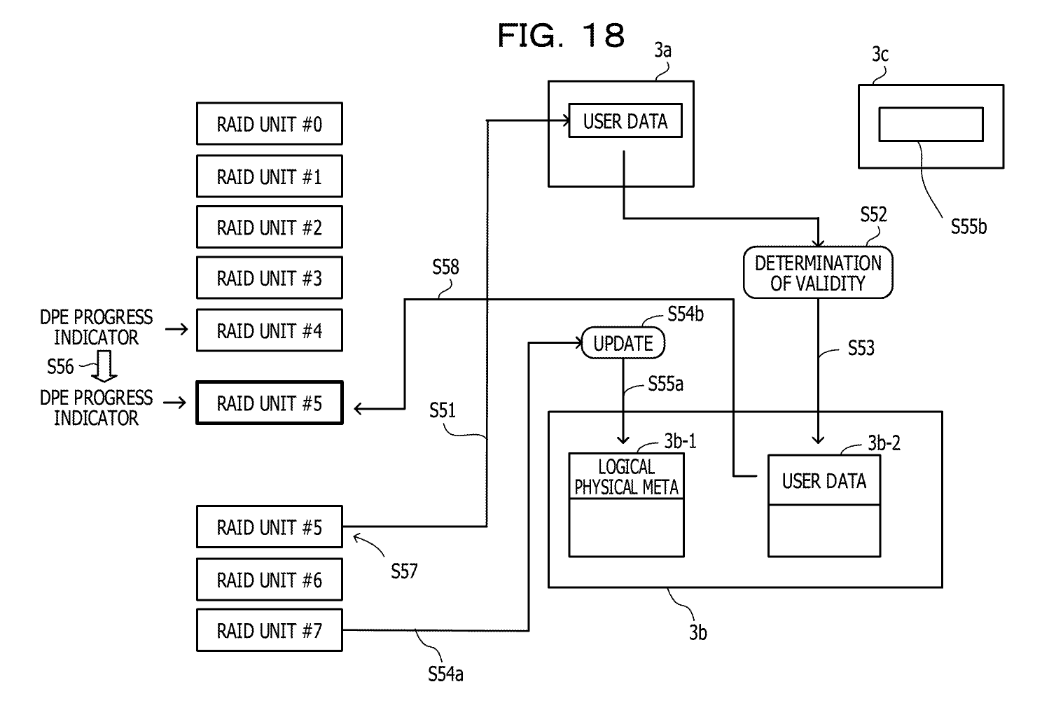

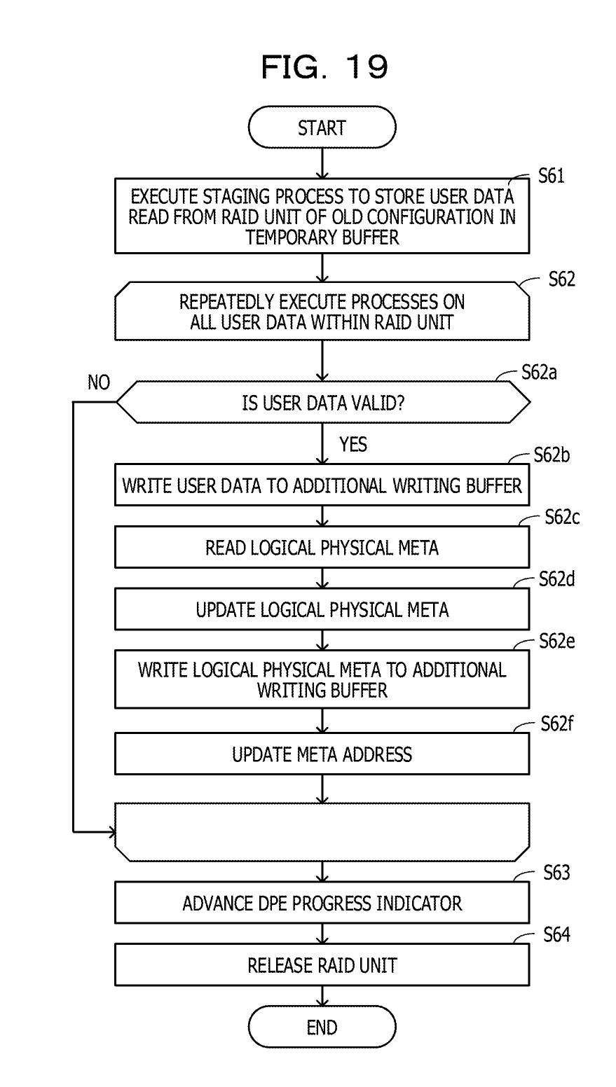

Next, the DPE process to be executed on the user data is described with reference to FIGS. 18 and 19. FIG. 18 is a diagram describing an example of the DPE process to be executed on the user data.

In step S51, the controller 1b executes the staging process to store user data of the RAID unit #5 of the old configuration in the temporary buffer 3a.

In step S52, the controller 1b determines whether the user data stored in the temporary buffer 3a is valid or invalid.

If the user data is valid, the controller 1b additionally writes the user data to a user buffer region 3b-2 of the additional writing buffer 3b in step S53.

In step S54a, the controller 1b reads logical physical meta corresponding to the user data from a RAID unit in which the logical physical meta corresponding to the user data is stored.

In step S54b, the controller 1b updates point information of the user data corresponding to the logical physical meta since the physical position of the user data is changed.

In step S55a, the controller 1b additionally writes the logical physical meta after the update to the logical physical meta buffer 3b-1 of the additional writing buffer 3b.

In step S55b, the controller 1b updates information pointing the logical physical meta of the meta address stored in the meta address cache memory 3c since the physical address of the logical physical meta is changed. The processes of steps S51 to S55b are repeatedly executed on all the user data stored in the temporary buffer 3a.

In step S56, the controller 1b advances the DPE progress indicator for RAID units to the RAID unit #5.

In step S57, the controller 1b releases the RAID unit #5. In the case where the user data able to be made invalid exists in the RAID unit of the old configuration, the RAID unit is released upon the rebuilding of RAID units of the new configuration, the data rearrangement is not executed, and the amount of a task of executing the data rearrangement is reduced.

In step S58, the controller 1b writes the user data back to the RAID unit of the new configuration asynchronously with the DPE process when the additional writing buffer 3b (user data buffer region 3b-2) becomes full of the user data due to IO extension.

FIG. 19 is a flowchart o the DPE process to be executed on the user data.

In step S61, the controller 1b executes the staging process to store the user data read from the RAID unit of the old configuration in the temporary buffer 3a.

In step S62, the controller 1b repeatedly executes processes of steps S62a to S62f on all the user data within the RAID unit. When the processes of steps S62a to S62f are completed on all the user data, the process proceeds to step S63.

In step S62a, the controller 1b determines whether user data is valid or invalid. If the user data is valid, the process proceeds to step S62b. If the user data is not valid, the controller 1b determines whether the next user data is valid or invalid.

In step S62b, the controller 1b writes the user data to the additional writing buffer 3b.

In step S62c, the controller 1b reads logical physical meta.

In step S62d, the controller 1b updates the logical physical meta.

In step S62e, the controller 1b writes the logical physical meta to the additional writing buffer 3b.

In step S62f, the controller 1b updates the meta address.

In step S63, the controller 1b advances the DPE progress indicator to the RAID UNIT.

In step S64, the controller 1b releases the RAID unit.

IO Control During DPE Process

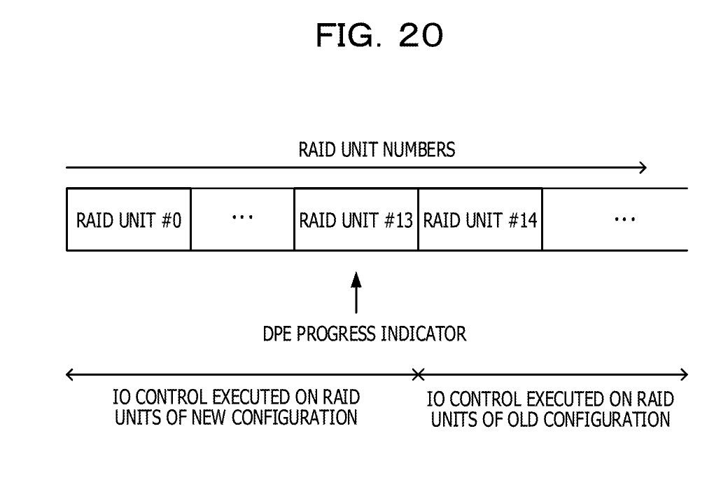

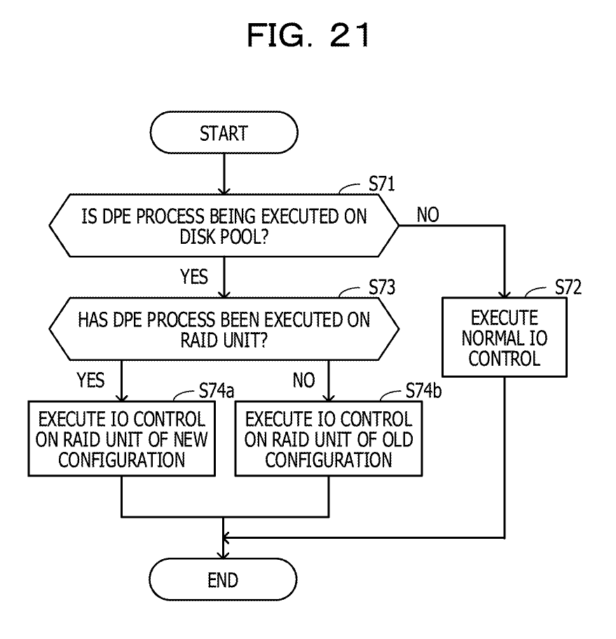

Next, IO control during the DPE process is described with reference to FIGS. 20 and 21. FIG. 20 is a diagram describing an example of the IO control during the DPE process. Regarding the IO control during the DPE process, the controller 1b executes, based on RAID unit numbers of RAID units on which the DPE process has been executed, the IO control (read IO and write IO) on the RAID units on which the DPE process has been executed and that serve as RAID units of the new configuration.

The example illustrated in FIG. 20 assumes that the DPE process has been executed on RAID units #0 to #13. In this case, the controller 1b executes the IO control on the RAID units #0 to #13 as RAID units of the new configuration and executes the IO control on RAID units #14 and later as RAID units of the old configuration.

FIG. 21 is a flowchart of the IO control during the DPE process.

In step S71, the controller 1b determines whether or not the DPE process is being executed on the disk pool to be accessed. If the DPE process is not being executed, the process proceeds to step S72. If the DPE process is being executed, the process proceeds to step S73.

In step S72, the controller 1b executes normal IO control.

In step S73, the controller 1b determines, based on the DPE progress indicator, whether or not the DPE process has been executed on the RAID unit to be accessed. If the DPE process has been executed on the RAID unit to be accessed, the process proceeds to step S74a. If the DPE process has not been executed on the RAID unit to be accessed, the process proceeds to step S74b.

In step S74a, the controller 1b executes the IO control on the RAID unit to be accessed as a RAID unit of the new configuration.

In step S74b, the controller 1b executes the IO control on the RAID unit to be accessed as a RAID unit of the old configuration.

As described above, according to the embodiment, a new RAID unit is generated based on the number of storage devices within the disk pool after capacity expansion, and the data rearrangement is executed. Thus, the degree of freedom of the expansion of the storage capacity may be improved. Since storage devices may be additionally installed one by one in the disk pool, small-scale expansion of the storage capacity may be executed while updating physical position information of the meta structure, compared with the case where the storage capacity is expanded by additionally installing a storage device, depending on RAID units of the old configuration, for example.

In the DPE process according to the embodiment, since the writing of invalid data is not executed upon the rearrangement of data read from the old configuration, useless writing to a disk is not executed, an assigned capacity after expansion may be reduced, and the expansion process may be executed at a high speed.

The aforementioned processing functions of the storage control apparatus 1 may be achieved by a computer. In this case, the program in which the details of the processing to be executed by the functions of the storage control apparatus 1 are described is provided. When the computer executes the program, the aforementioned processing functions are achieved in the computer.

The program in which the details of the processing are described may be recorded in a computer-readable recording medium. Examples of the computer-readable recording medium are a magnetic storage device, an optical disc, a magneto optical recording medium, and a semiconductor memory. Examples of the magnetic storage device are a hard disk device (HDD), a flexible disk (FD), and a magnetic tape. Examples of the optical disc are a DVD, a DVD-RAM, a CD-ROM, and a CD-RW. An example of the magneto optical recording medium is a magneto optical (MO) disc.

In the case where the program is distributed, a portable recording medium in which the program is recorded and that is a DVD, a CD-ROM, or the like may be on sale. In addition, the program may be stored in a storage device of a server computer and transferred from the server computer to another computer via a network.

The computer that is configured to execute the program may store, in a storage device of the computer, the program recorded in the portable recording medium or transferred from the server computer. Then, the computer reads the program from the storage device of the computer and executes the processes in accordance with the program. The computer may read the program directly from the portable recording medium and execute the processes in accordance with the program.

In addition, every time the program is transferred from the server computer connected to the computer via the network, the computer may sequentially execute the processes in accordance with the received program. In addition, a part or all of the aforementioned processing functions may be achieved by an electronic circuit such as a DSP, an ASIC, or a PLD.

Although the embodiment is described above, the configurations of the sections described in the embodiment may be replaced with similar configurations having the same functions as those described in the embodiment. In addition, another arbitrary constituent section and another arbitrary process may be added. Furthermore, arbitrary two or more of the configurations (characteristics) described in the embodiment may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control apparatus comprising:
a memory; and
a processor coupled to the memory and configured to:
execute a capacity expansion on a storage group including a plurality of storage devices,
generate a plurality of first data storage regions in accordance with the number of storage devices within the storage group after the capacity expansion, and
execute data rearrangement within the storage group after the capacity expansion for each of the plurality of first data storage regions.

2. The storage control apparatus according to claim 1,
wherein the processor migrates data stored in each of a plurality of second data storage regions within the storage group before the capacity expansion to a temporary storage region, and
wherein the processor executes the data rearrangement within the storage group after the capacity expansion by writing the data migrated to the temporary storage region back to the plurality of first data storage regions.

3. The storage control apparatus according to claim 2,
wherein the processor executes the data rearrangement in a process that varies depending on first management data to be used to manage physical addresses of user data stored in the storage devices, second management data to be used to manage physical addresses of the first management data stored in the storage devices, or the user data, while the data stored in the plurality of second data storage regions is the first management data, the second management data, or the user data.

4. The storage control apparatus according to claim 3,
wherein if the data stored in the plurality of second data storage regions is the first management data, the processor determines the validity of the first management data by migrating the first management data stored in the plurality of second data storage regions within the storage group before the capacity expansion to the temporary storage region for each of the plurality of second data storage regions,
wherein the processor reads the first management data from the temporary storage region and writes the read first management data to a buffer if the first management data is valid,
wherein the processor updates the second management data to be used to manage the physical addresses of the first management data, and
wherein the processor executes the data rearrangement within the storage group after the capacity expansion by writing the first management data written to the buffer back to the plurality of first data storage regions when the buffer becomes full of the first management data.

5. The storage control apparatus according to claim 4,
wherein if data included in the first management data and stored in an second data storage region is invalid, the processor releases the second data storage region upon the generation of the plurality of first data storage regions.

6. The storage control apparatus according to claim 3,
wherein if the data stored in the plurality of second data storage regions is the second management data, the processor migrates the second management data stored in the plurality of second data storage regions within the storage group before the capacity expansion to the temporary storage region for each of the plurality of second data storage regions, and
wherein the processor executes the data rearrangement within the storage group after the capacity expansion by writing the second management data migrated to the temporary storage region back to the plurality of first data storage regions.

7. The storage control apparatus according to claim 3,
wherein if the data stored in the plurality of second data storage regions is the user data, the processor determines the validity of the user data by migrating the user data stored in the plurality of second data storage regions within the storage group before the capacity expansion to the temporary storage region for each of the plurality of second data storage regions,
wherein if the user data is valid, the processor reads the user data from the temporary storage region and writes the read user data to a first buffer,
wherein the processor updates the first management data to be used to manage the physical addresses of the user data and writes the first management data after the update to a second buffer,
wherein the processor updates the second management data to be used to manage the physical addresses of the first management data, and
wherein the processor executes the data rearrangement within the storage group after the capacity expansion by writing the user data written to the first buffer back to the plurality of first data storage regions when the first buffer becomes full of the user data.

8. The storage control apparatus according to claim 7,
wherein if data included in the user data and stored in an second data storage region is invalid, the processor releases the second data storage region upon the generation of the plurality of first data storage regions.

9. The storage control apparatus according to claim 2,
wherein the processor manages the progress of the data rearrangement, sets a storage region already indicated by a progress indicator to a first data storage region, and sets a storage region yet to be indicated by the progress indicator to an second data storage region.

10. A storage control method for a storage control apparatus, the storage control method comprising:
executing a capacity expansion on a storage group including a plurality of storage devices;
generating a plurality of first data storage regions in accordance with the number of storage devices within the storage group after the capacity expansion; and
executing data rearrangement within the storage group after the capacity expansion for each of the plurality of first data storage regions.
